(19) United States
(12) Patent Application Publication
(10) Pub. No.: US 2015/0126291 A1
(43) Pub. Date: May 7, 2015

(54) Bevel Universal Joint

(71) Applicant: ASHOT ASHKELON INDUSTRIES LTD, Ashkelon (IL)

(72) Inventor: Nimrod EITAN, Tel Aviv (IL)

(21) Appl. No.: 14/533,109

(22) Filed: Nov. 5, 2014

Related U.S. Application Data
(60) Provisional application No. 61/899,894, filed on Nov. 5, 2013.

(51) Int. Cl. F16D 3/16

(52) U.S. Cl. CPC F16D 3/16
USPC 464/106

(57) ABSTRACT

A universal joint may comprise a first joint member terminating in either a first pair of cones or a first pair of cone slices, wherein apical ends of said first pair of cones or first pair of cone slices form first and second sockets, the first and second sockets facing each other; a second joint member terminating in either a second pair of cones or a second pair of cone slices, wherein apical ends of said second pair of cones or second pair of cone slices form third and fourth sockets, the third and further sockets facing each other; a coupler fitted into the first, second, third and fourth sockets, wherein torque is transmitted directly between the first joint member and the second joint member via side walls of the two pairs of cones or cone slices.

### FIELD AND BACKGROUND OF THE INVENTION

The present invention relates to apparatuses and methods for universal joints, and more particularly, to universal-joints in which all or part of the torque transmission between the joint members is directly between the joint members.

A universal joint (see FIG. 1) is a component that allows transmission of rotational motion and torque through angled axes. One common use for these universal joints, particularly booted universal-joints, is the flap deploying system of commercial aircraft.

As a result of the constant bending loads, which may even include alternating bending loads, and the need to endure long term stress, for example twenty years of such stress in the case of a commercial aircraft flap deploying system, the amount and rate of wear of the universal joint are very important.

In some cases, a narrow articulation angle joint that transfers high torque is needed. In some case, space restrictions do not allow for a long universal joint.

There is a compelling need to have a universal joint which allows reduced wear with a longer lifetime. It would be particularly advantageous to have such a universal joint that, in some embodiments at least, can provide a high torque transfer at a narrow articulation angle in restrictive space. It would also be advantageous if the universal joint would able to be quickly and easily disconnected.

### SUMMARY OF THE PRESENT INVENTION

One aspect of the present invention is a universal joint, comprising a first joint member terminating in either a first pair of cones or a first pair of cone slices, wherein apical ends of said first pair of cones or first pair of cone slices form first and second sockets, the first and second sockets facing each other; a second joint member terminating in either a second pair of cones or a second pair of cone slices, wherein apical ends of said second pair of cones or second pair of cone slices form third and fourth sockets, the third and fourth sockets facing each other; a coupler fitted into the first, second, third and fourth sockets, wherein torque is transmitted directly between the first joint member and the second joint member via side walls of the two pairs of cones or cone slices.

Another aspect of the present invention is a short universal joint for high torque having a narrow articulation angle, the universal joint comprising a first joint member terminating in a first pair of cone slices, wherein apical ends of said first pair of cone slices form first and second sockets, the first and second sockets facing each other; a second joint member terminating in a second pair of cone slices, wherein apical ends of said second pair of cone slices form third and fourth sockets, the third and further sockets facing each other; a coupler fitted into the first, second, third and fourth sockets, wherein torque is transmitted directly between the first joint member and the second joint member via side walls of the two pairs of cone slices and not through the coupler.

A further aspect of the present invention is a universal joint, comprising a first joint member terminating in either a first pair of cones or a first pair of cone slices, wherein apical ends of said first pair of cones or first pair of cone slices form first and second sockets, the first and second sockets facing each other; a second joint member terminating in either a second pair of cones or a second pair of cone slices, wherein apical ends of said second pair of cones or second pair of cone slices form third and fourth sockets, the third and further sockets facing each other; a cruciform coupler fitted into the first, second, third and fourth sockets, wherein the torque between the first and second joint members is transmitted jointly by being transmitted both (a) directly from the first joint member to the second joint member via external walls of the two pairs of cones or cone slices and (b) via the cruciform.

A still further aspect of the present invention is a method of quickly disconnecting a universal joint, comprising releasing a lock ring on at least one joint member having a slot; and separating two cones, or two cone slices, whose apical ends face each other at proximal ends of a first joint member, to expose a spherical coupler fitted in a first pair of sockets of the first joint member and in a second pair of sockets of the second joint member, the first and second pair of sockets defining respectively concave apical ends of cones of the first and second pairs of cones. These and other features, aspects and advantages of the present invention will become better understood with reference to the following drawings, descriptions and claims.

### BRIEF DESCRIPTION OF THE DRAWINGS

Various embodiments are herein described, by way of example only, with reference to the accompanying drawings, wherein:

FIG. 1 is an exploded view of a prior art non-constant velocity universal joint where the torque is transmitted from joint member to joint member through a center cross;

FIG. 2 is an sectional view of a prior art constant velocity universal joint such as a Rzeppa Joint, a Britfield Joint or a Carl Weiss Joint, where the torque between the joint members is transmitted through grooves and spheres;

FIG. 3 is a schematic view of a basic geometric principle applied to a pair of cones, in accordance with one embodiment of the present invention;

FIG. 4 is a continuation of the schematic view of the basic geometric principle applied to two pairs of cones, in accordance with one embodiment of the present invention;

FIG. 5 is an isometric schematic view of a central structure of a universal joint showing a spherical coupler coupling four cones, in accordance with one embodiment of the present invention;

FIG. 6A is an isometric view of a first joint member of a universal joint, in accordance with one embodiment of the present invention;

FIG. 6B is a top view of the first joint member without a coupler, in accordance with one embodiment of the present invention;

FIG. 7 is an isometric view of a universal joint, in accordance with one embodiment of the present invention;

FIG. 8 is an isometric view of a universal joint in connected and disconnected states, in accordance with one embodiment of the present invention;

FIG. 9 is an isometric view of a narrow angle bevel universal joint, in accordance with one embodiment of the present invention;

FIG. 9A is an isometric view of one joint member of FIG. 9 showing cone slices, in accordance with one embodiment of the present invention;

FIG. 10 is an isometric view of a universal joint whose torque transmission is shared with a center cross, in accordance with one embodiment of the present invention;

FIG. 11A is a front view of a joint member of the universal joint of FIG. 10, in accordance with one embodiment of the present invention;

FIG. 11B is a side view of a the joint member of the universal joint of FIG. 11A, in accordance with one embodiment of the present invention;

FIG. 12 is an exploded view of the universal joint of FIG. 10; and

FIG. 13 is a flow chart showing a method, in accordance with one embodiment of the present invention.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

The present invention generally provides a universal joint that transmits torque directly from one joint member to the second joint member. In one preferred embodiment, the universal joint is utilized in the flap deploying system of commercial aircraft. In that example, the universal joint is a component of the flap deploying system that has to endure twenty years of use in the commercial aircraft. Other applications of the universal joint of the present invention include medical devices.

A universal joint may comprise a first joint member terminating in either a first pair of cones or a first pair of cone slices, wherein apical ends of said first pair of cones or first pair of cone slices form first and second sockets, the first and second sockets facing each other; and a second joint member terminating in either a second pair of cones or a second pair of cone slices, wherein apical ends of said second pair of cones or second pair of cone slices form third and fourth sockets, the third and further sockets facing each other. Further, a coupler, which may in preferred embodiments be spherical (or substantially spherical or partly spherical (i.e. occupying a spherical segment) or cruciform (whose central portion may be cylindrical or cubical or spherical) may form a common center by being fitted into the first, second, third and fourth sockets. In some preferred embodiments, torque is transmitted directly between the first joint member and the second joint member for example via side walls of the two pairs of cones or cone slices. In the case of cone slices, the short dimension is a good solution to space restrictions in the flap deploying system of aircraft and for the need to have high torques transferred at a very narrow articulation angle. In other preferred embodiments torque transmission is shared between a center element such as a cross (cruciform) and the direct transmission between the cones or cone slices of one joint member and the cones or cone slices of the second joint member. This may provide reduced wear of the lifetime of the joint and may extend the lifetime of the universal joint.

In contrast to prior art universal joints, in which the torque between the yokes (joint members), and particularly all of the torque between the yokes (joint members), is transmitted by way of some medium such as a cross or a sphere, in the present invention, in certain preferred embodiments all of the torque between the joint members is transmitted between side walls of cones or cone slices that form the ends of the joint members. For example, a sphere may keep the joint members in place by creating a common center and may do so without torque being transmitted through the sphere. In other preferred embodiments, transmission of the torque between the joint members is shared between the side walls of the cones or cone slices that form the ends of the joint members. In further contrast to prior art universal joints, in which the joint design cannot be utilized where space restrictions dictate very short universal joints, the present invention, in preferred embodiments utilized cone slices, may achieve a joint that transfers high torque but requires a very narrow articulation angle. By using just a slice of the cones instead of the full cones, this preferred embodiment of the present invention achieves a narrow angle high torque and short-dimensioned joint which may be useful for very narrow articulation angles, for example angles of up to 5 degrees. The edge of the yoke/joint member may be flat and short. In contrast to prior art universal joints that can not be manually disconnected and that may require substantial effort to disconnect, the universal joint of the present invention may disconnect quickly and with only a relatively small manual effort (in some preferred embodiments sliding a lock ring and pulling apart two cones or cone slices). The ability to quickly disconnect provides an advantage in certain applications, including where the universal joint is part of a medical device. In still further contrast to prior art universal joints, which wear out too quickly to have a long lifetime, the universal joint of the present invention may allow reduced wear and a longer lifetime.

The principles and operation of an apparatus and method for a beveled universal joint according to the present invention may be better understood with reference to the drawings and the accompanying description.

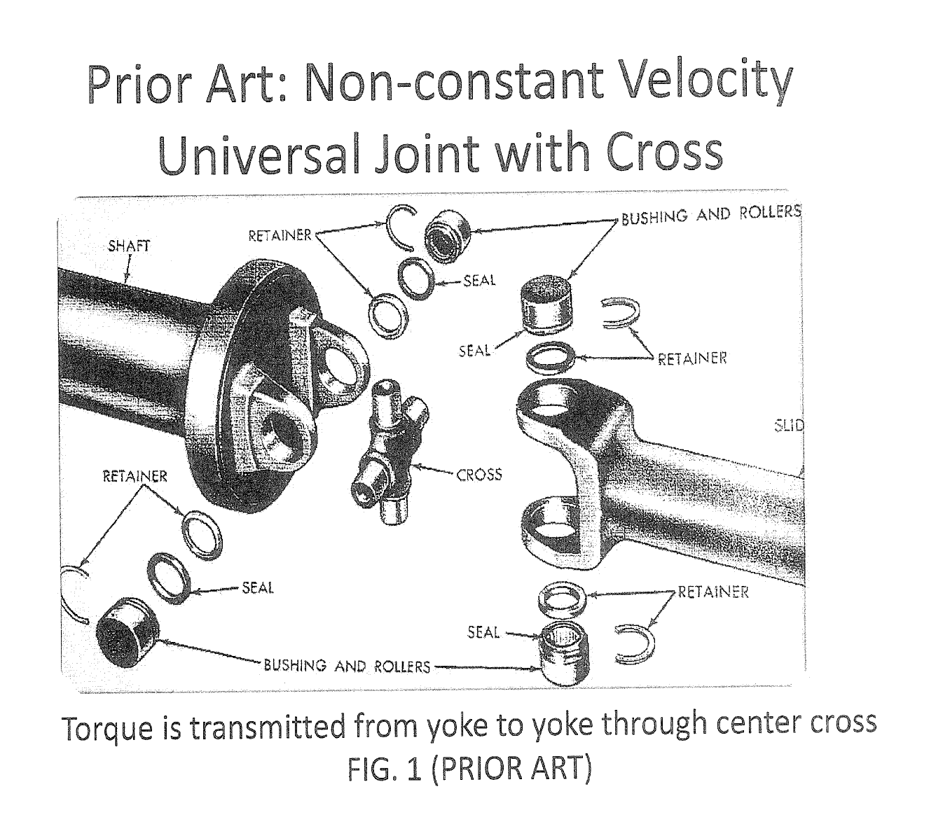

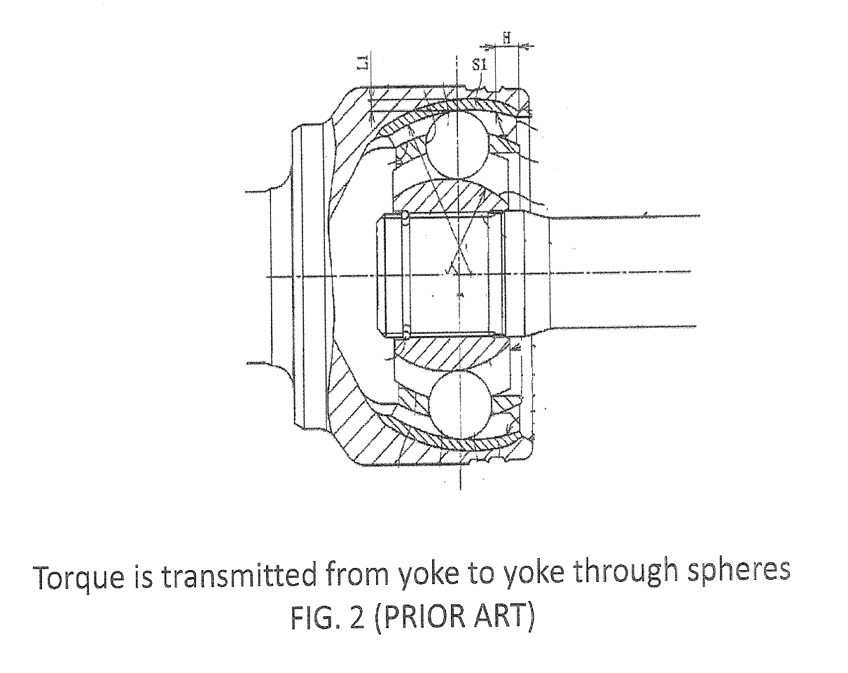

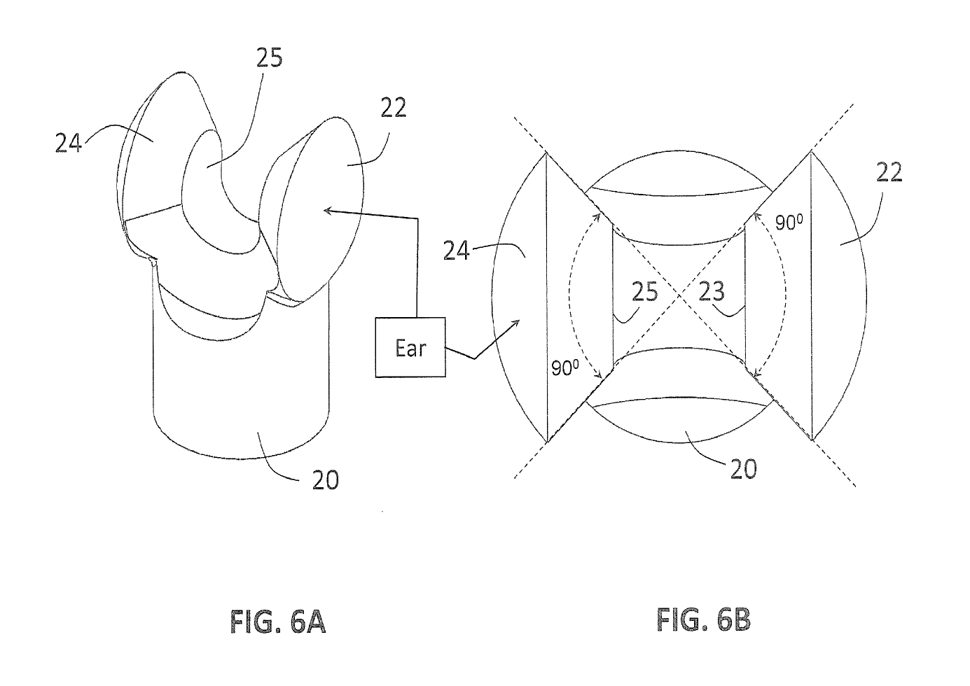

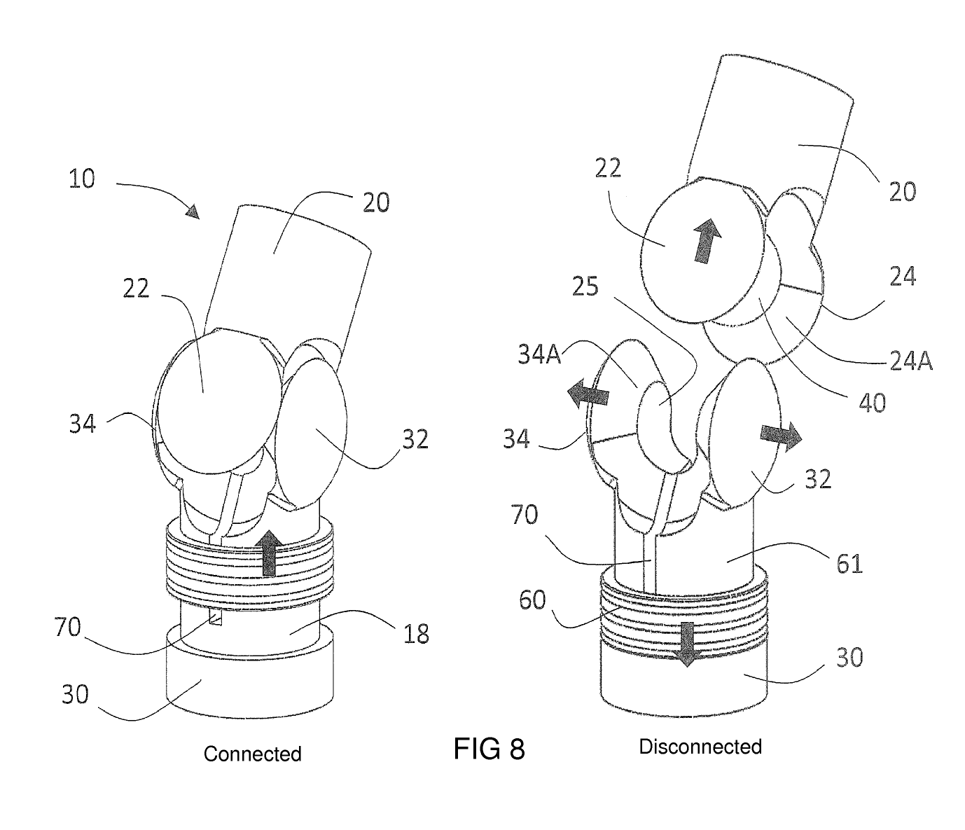

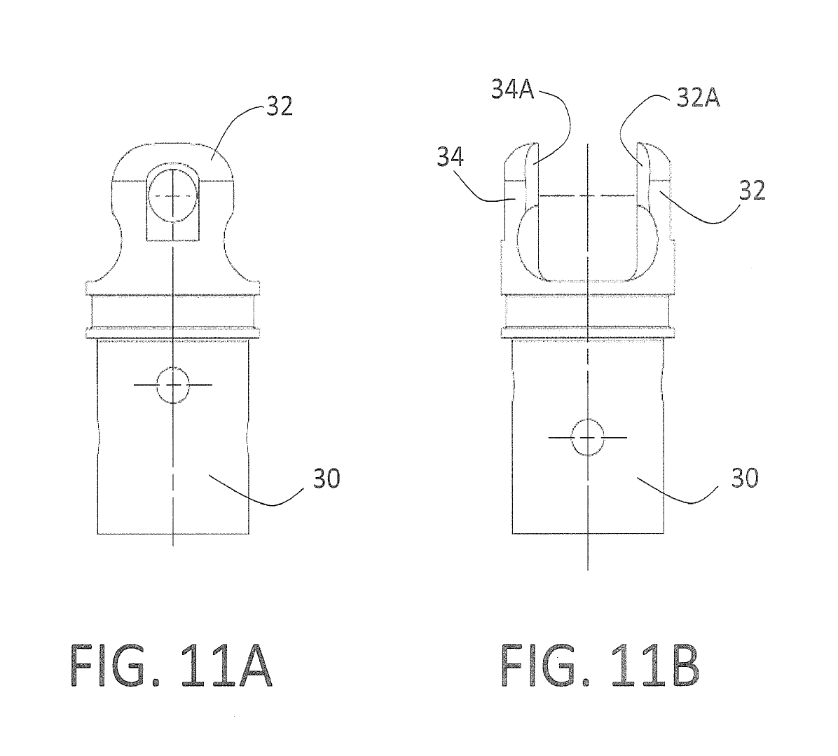

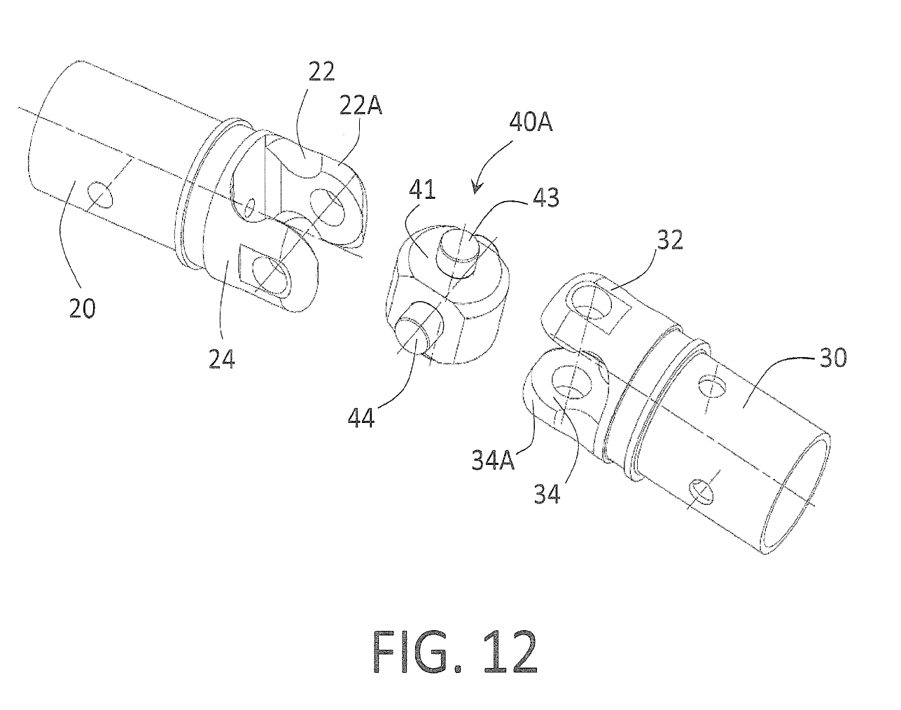

As seen from FIGS. 1-12, the present invention may be described as a universal joint 10 that may comprise a first joint member 20 and a second joint member 30. As shown in FIG. 6A, FIG. 8 and FIG. 12, first joint member 20 may terminate in a first pair of cones 22, 24 which may be called the first cone 22 and the second cone 24.

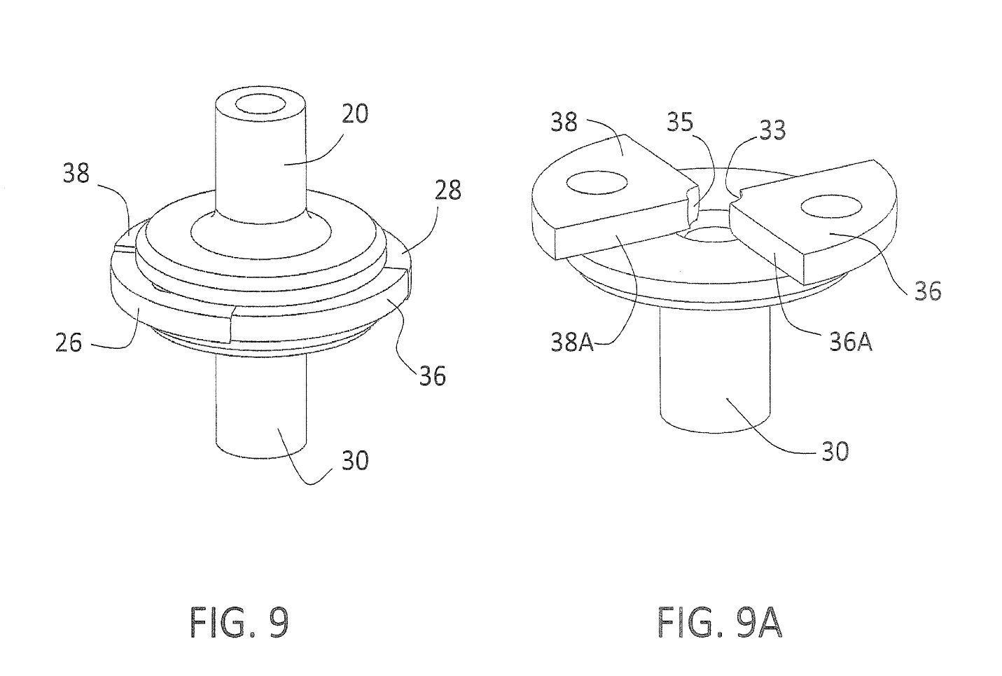

As shown in FIG. 9A, in other preferred embodiments, the first joint member 20 may terminate in a first pair of cone slices 26, 28. These cone slices 26, 28 are slices (of what otherwise may have been full cones) that are used in certain preferred embodiments to provide a short dimension for narrow angle articulation in tight spaces, where high torque transmission is still needed. As can be seen from FIG. 9A, each cone slices 36, 38 includes side surfaces 36A and 38A. Side surfaces 36A and 38A, are curved faces of the cone slices 36, 38 (though such curvature may not be discernible from the drawings (due to the narrowness of these surfaces 36A, 38A).

References to a “cone” or “cones” in any preferred embodiment of the present invention (not including references to a cone slice or cone slices) should be understood as also encompassing cone segments. In fact most of the drawings herein of the present invention depict mere segments of cones as opposed to full cones. Furthermore, as discussed more fully below, all cones referred to in the present invention have been truncated along a line demarcating a socket and do not reach their apex.

Cones 22, 24 do not come to a point at the apical end but are truncated along a concave line. Accordingly, as seen from FIG. 6A, apical ends 29 of said first pair of cones 22, 24 or first pair of cone slices 26, 28 may form first socket 23 and second socket 25. The first and second sockets 23, 25 may face each other as seen from FIG. 6B. As seen from the isometric view of FIG. 6A and the top view of FIG. 6B, the sides of the cones 22, 24 may be described as bevel faces. The cones may also be referred to as ears because they may be generally shaped like a shape of an ear.

A second joint member 30 may similarly terminate in a second pair of cones 32, 34, which may be called third cone 32 and fourth cone 34. As shown in FIG. 9, in another preferred embodiment, the second joint member 30 may terminate in a second pair of cone slices 36, 38.

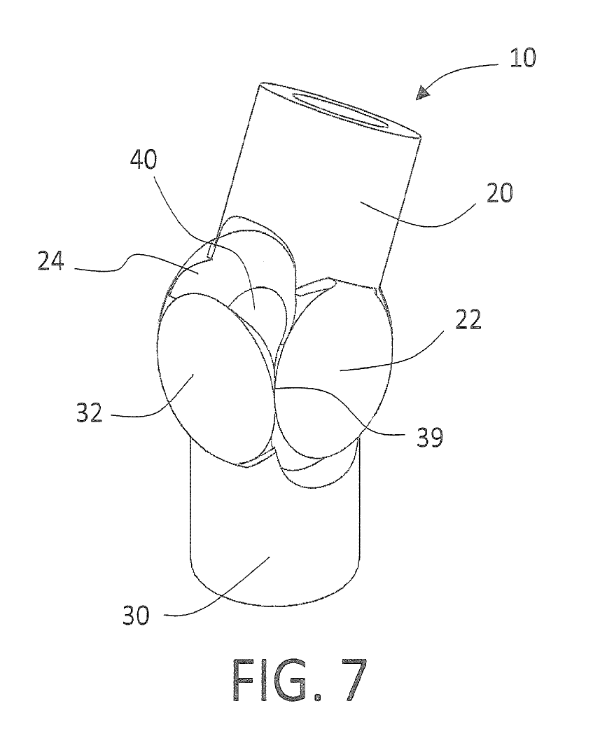

Similarly, cones 32, 34 do not come to a point at the apical end but are truncated along a concave line. Accordingly, apical ends 39 of the second pair of cones 32, 34 or second pair of cone slices 36, 38 may form third socket 33 and fourth socket 35. The third and fourth sockets 33, 35 may face each other as best appreciated from FIG. 7 and from FIG. 8 (disconnected state).

The first and second joint members 20, 30 may be structural identical to one another (puffing aside peripheral locking elements or the like) so that third and fourth cones 32, 34 are shaped like first and second cones 22, 24 except that the second pair of cones (or cone slices) of the second joint member is oriented 90 degrees away from the first pair of cones (or cone slices) of the first joint member, as best seen from FIG. 8 (disconnected state). Accordingly, the sides of the third and fourth cones 32, 34 may likewise be described as bevel faces. The third and fourth cones 32, 34 may also be referred to as ears because they may be generally shaped like a shape of an ear.

As seen from FIG. 6, FIG. 8, FIG. 9A, FIG. 12, in all embodiments, the two cones (or cone slices) of each pair of cones (or cone slices) are oriented oppositely in that if, for example the apical end of the first cone (or cone slice) is pointing leftward, the apical end of the second cone (or cone slice) is pointing rightward. Further, in a preferred embodiment, apical ends of the first and second cones 22, 24 may face each other along an axis perpendicular to the longitudinal axis of the remainder of first joint member 20 (and perpendicular to the longitudinal axis of the first joint member generally). Likewise, the apical ends of the third and fourth cones 32, 34 may face each other along an axis perpendicular to the longitudinal axis of the remainder of second joint member 30 (and perpendicular to the longitudinal axis of the second joint member generally). Accordingly, when the first and second joint members 20, 30 are in a straight configuration and the longitudinal axes of the first and second joint members are identical (or substantially identical), the apical ends of the first and second cones may be said to face each other along a first axis that is perpendicular (or substantially perpendicular) to this longitudinal axis of both joint members, and the apical ends of the third and fourth 32, 34 cones may then be said to face each other along a second axis that may be perpendicular (or substantially perpendicular) both to the longitudinal axis of the joint members and to the first axis.

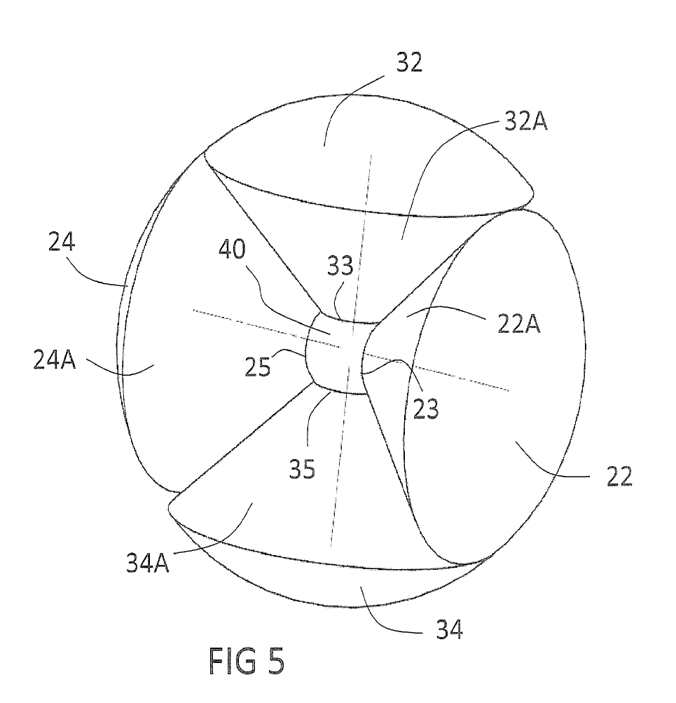

Universal joint 10 may further include a coupler 40. Coupler 40 may be fitted into the first, second, third and fourth sockets at the apical ends of the four cones) or cone slices), for example so as to accommodate and hold in place the first, second, third and fourth cones (or cone slices). Coupler 40, as seen from FIG. 5, coupler 40 creates a common center for both pairs of cones (or cone slices) and this may hold the first and second joint members 20, 30 in place.

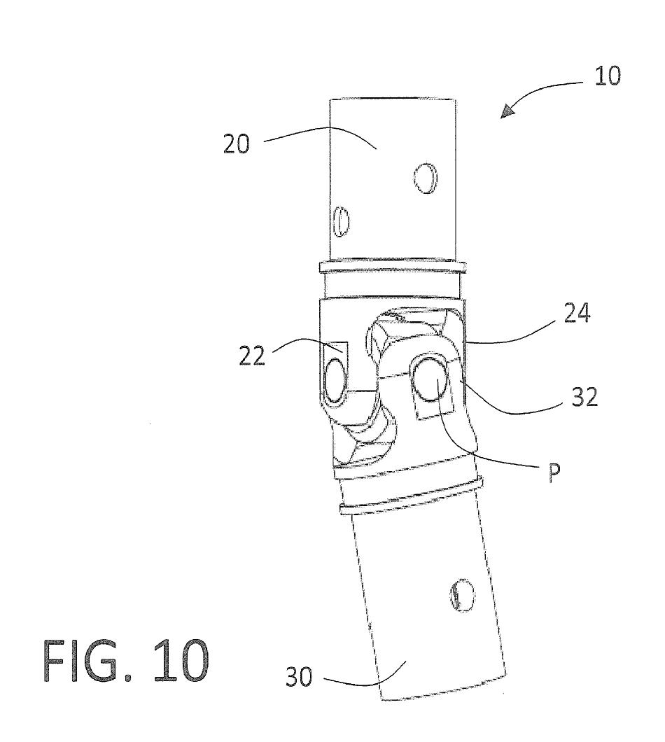

With the exception of the preferred embodiment that may be called the “shared torque” embodiment depicted in FIGS. 10, 11A, 11B and 12, where torque is shared jointly between the coupler and the walls of the cones (or cone slices), the coupler 40 is not subjected to torque from the first and second joint members 20, 30 and hence does not transmit torque between the first and second joint members 20, 30.

Rather, the torque may be transmitted directly between the first joint member 20 and the second joint member 30. The transmission of the torque may occur via walls, for example side walls 22A, 24A, 32A, 34A (see FIG. 5), which may be bevel faces, of the two pairs of cones 22, 24, 32, 34 or cone slices. FIG. 7 shows a contact line 99 between cones 22, 32 for transmission of torque, in accordance with one preferred embodiment. The contact line 99 represents a collection of points where cone 22 and cone 32 are constantly in contact. In the preferred embodiment shown in FIG. 8 and the preferred embodiment shown in FIGS. 9A and 9B, all of the torque between the first and second joint members may be transmitted directly between the first joint member and the second joint member. In the preferred embodiments of FIG. 8 through FIG. 9A, the coupler 40 does not transmit torque between the first and second joint members but rather may just hold the cones (or cone slices) in place.

Coupler 40 may be spherical or substantially spherical as shown in FIG. 5. Use of at least a spherical segment or an interrupted spherical segment for the shape of coupler 40 may facilitate having coupler 40 not be subjected to a torsional force. FIGS. 6A and 8 (see disconnected state) also depict the combined two pairs of sockets of the two pairs of cones that the first and second joint members terminate in, as together occupying a sphere. Accordingly, in that case, coupler 40 is spherical. FIG. 9, which depicts cone slices for a narrow angle universal joint, also allows for the coupler to be spherical, although in certain versions of the embodiment of FIG. 9-9A the coupler 40 may be a sphere truncated at the top and at the bottom and hence coupler 40 may be said to merely occupy a spherical segment.

Torque may be transmitted through the cones because, as shown in FIG. 5 and FIG. 7, where the first and second joint members terminate in respective cones, a side wall of each cone of the first pair of cones may be in constant contact with side walls of both cones of the second pair of cones and a side wall of each cone of the second pair of cones may be in constant contact with side walls of both cones of the first pair of cones.

As shown in FIG. 9 and FIG. 9A, where the first and second joint members 20, terminate in respective first and second pairs of cone slices, a side wall of each cone slice of the first pair of cone slices may be in constant contact with side walls of both cone slices of the second pair of cone slices and a side wall of each cone slice of the second pair of cone slices may be in constant contact with side walls of both cone slices of the first pair of cone slices.

Typically, an apex angle of each cone is 90 degrees. For example, in one preferred embodiment, the apex angle of each cone or cone slice of the first pair of cones or cone slices is equal to one another and the apex angle of each cone or cone slice of the second pair of cones or cone slices is equal to one another. However, the apex angle of the cones in the first pair of cones may not necessarily match the apex angle of the cones in the second pair of cones (although they would if all four cones had apex angles of 90 degrees). For example, an apex angle of a cone or cone slice of the first pair of cones or cone slices may be unequal to an apex angle of a cone or cone slice of the second pair of cones or cone slices.

In one preferred embodiment, the apex angle of one cone (for example the first cone) or cone slice of the first pair of cones or cone slices together with the apex angle of one cone (for example the second cone) or cone slice of the second pair of cones or cone slices equals 180 degrees. The same is true of the second pair of cones or cone slices. In one example, the apex angles of the cones of the two pairs of cones may be 88 (first cone), 88 (second cone), 92 (third cone), 92 (fourth cone) or 90, 90, 90, 90 or 85 (third cone), 85 (fourth cone), 95 (first cone), 95 (second cone), with the two 85 degree apex angle cones (or 88 degree apex angle cones) being within the same pair of cones or cone slices. Accordingly, in preferred embodiments, the sum of the apex angles of the four cones (22, 24, 32, 34) or cone slices (26, 28, 36, 38) equals 360 degrees.

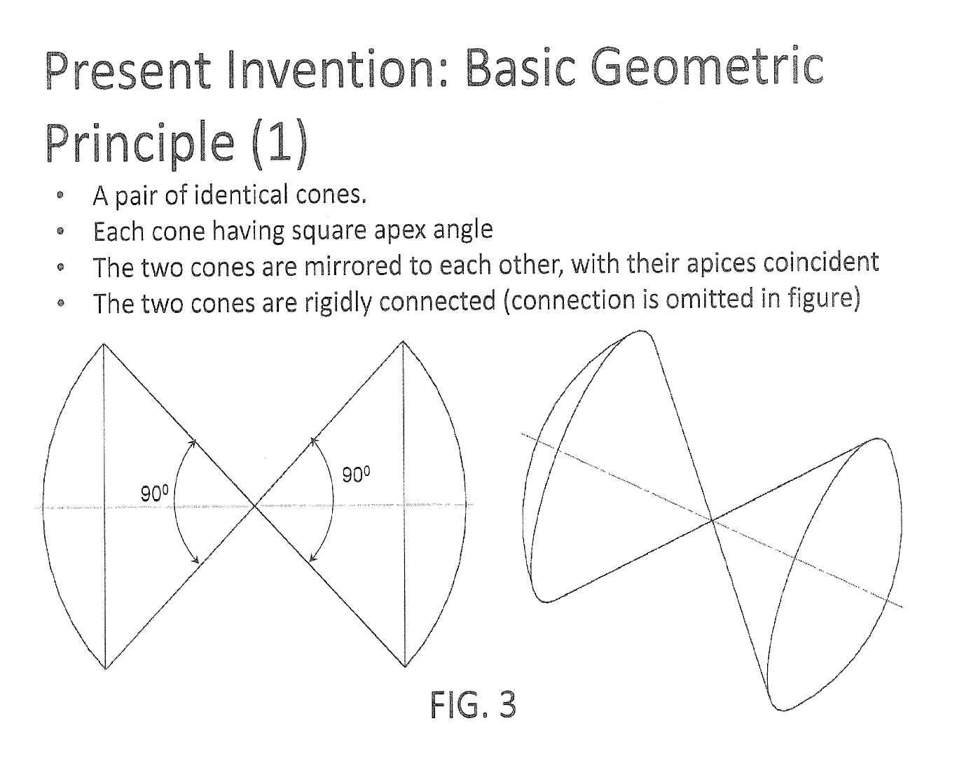

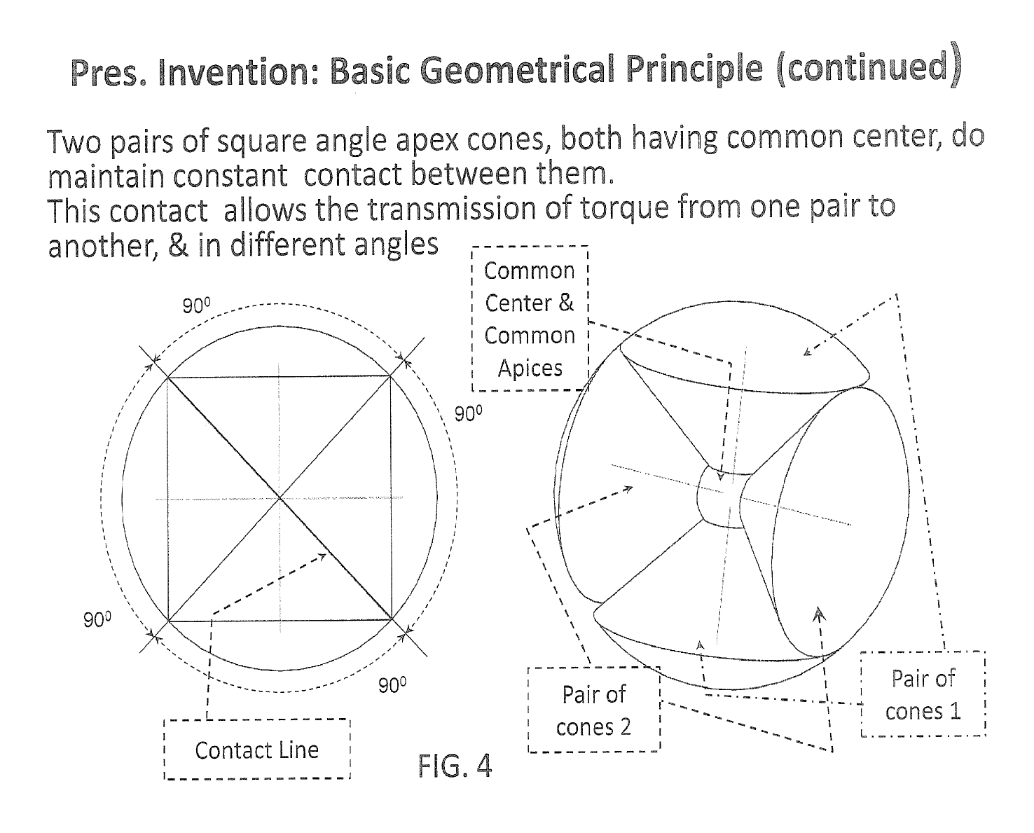

In any of the preferred embodiments described herein, for each pair of cones (or cone slices) each cone in the pair of cones (i.e. 22, 24 or 32, 34) (or cone slices) may have the same apex angle and in addition, as seen from FIG. 3, the apex of each cone in the pair of cones may be coincident. Moreover, in preferred embodiments, the apex of each cone of the first pair of cones and the apex of each cone of the second pair of cones are also all coincident, as shown in FIG. 4. Having the apex of all four cones or cone slices be coincident ensures constant contact between the neighboring cones (or cone slices). Furthermore, as noted (see contact line 99 in FIG. 7 for example), the constant contact between the neighboring cones or cone slices is in the form of a line, not a point.

When cones are used (as opposed to cone slices), joint members 20, 30 may deflect relative to one another (and away from the straight configuration) or articulate to an angle that may be approximately 25 degrees (or approximately 20 degrees or approximately 15 degrees in other preferred embodiments), although the specific examples of rotational degrees are not by any means a limiting feature.

As seen from FIG. 8, universal joint 10 may include a lock 60. For example, universal joint 10 may include a lock ring 60 around a neck 61 of at least one of the first and second joint members 20, 30. The neck 61 is defined to be at the (joining or proximal) end of a shaft connector of a joint member 20, 30. Lock ring 60 may be moved from a locked position to an unlocked position by sliding said lock ring 60, for example by sliding lock ring 60 from a position closer to the joint center where the coupler 40 is to an unlocked position further from the joint center where the coupler 40 is, as seen from FIG. 8 (see “connected” and “disconnected” states). Release of the lock ring 60 may allow disconnection of the universal joint by exerting a manual force to pull apart a pair of cones or cone slices. Having the ability to quickly disconnect is advantageous in some applications of the universal joint 10, such as in medical applications.

In some preferred embodiments, one or more joint members 20, 30 may have a slot 70 for facilitating disconnection of the universal joint 10. Slot 70 may extend from a neck 18 of at least one of the first and second joint members 20, 30 at a proximal end of the at least one of the first and second joint members 20, 30 to at least one of the first, second, third and fourth sockets.

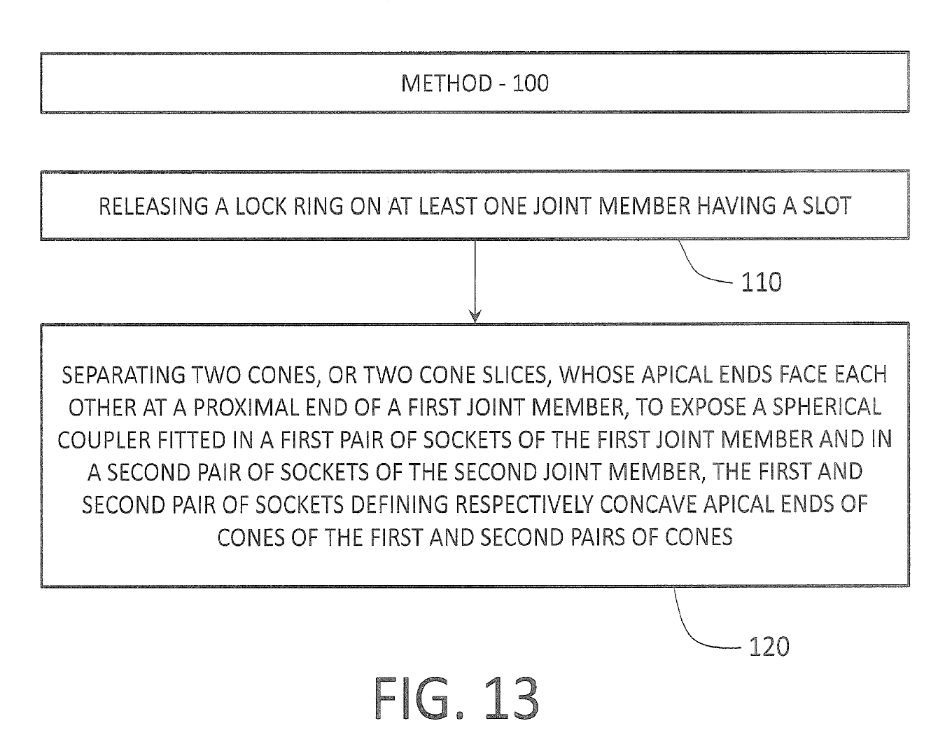

As shown in the flow chart of FIG. 13, the present invention may be described as a method of quickly disconnecting a universal joint. Method 100 may include a step 110 of releasing a lock ring on at least one joint member and a step 120 of separating two cones or two cone slices whose apical ends face each other at a proximal end of a first joint member, to expose a spherical coupler fitted in a pair of sockets of the first joint member and a pair of sockets of the second joint member. The first and second pair of sockets define, respectively, concave apical ends of cones of the first and second pairs of cones.

The separating may be facilitated by the presence of slot 70 extending from a neck of at least one joint member (20 or 30) to a socket of one or more cones (or cone slices). By having one slotted joint member, which provides material flexibility, and a sliding lock ring around its neck, the joint member (20 or 30) can be quickly disconnected and reconnected. When sliding the ring away from the joint center, and pulling the joint members 20, 30 away from each other, the sockets on the slotted joint member open due to material flexibility. The spherical coupler is allowed to slide out of the sockets. Once the first pair of cones is separated, the remaining pair of cones is easily separated. After reconnecting, slide the ring back to prevent unwarranted disconnect.

The separating step 120 may even be performed manually since the force needed may well be within a person's ability. In some versions of method 100, releasing the lock ring is effectuated by sliding the lock ring from a locked position closer to a coupler to an unlocked position further from a coupler.

In one preferred embodiment shown in FIG. 9 and FIG. 9A, the present invention may be described as a universal joint, and in particular, a short universal joint for high torque having a narrow articulation angle. As shown in FIG. 9 and FIG. 9A, the universal joint 10 may comprise a first joint member 20 terminating in a first pair of cone slices 26, 28, wherein apical ends of said first pair of cone slices form first and second sockets that face each other, and a second joint member 30 terminating in a second pair of cone slices 36, 38, wherein apical ends of said second pair of cone slices 36, 38 form third and fourth sockets that face each other. The universal joint 10 may also include a coupler 40 fitted into the first, second, third and fourth sockets, wherein torque is transmitted directly between the first joint member and the second joint member via side walls of the two pairs of cone slices and not through the coupler. In one preferred embodiment, the narrow articulation angle extends up to five degrees, compared to approximately 25 degrees when a full cone is used. In other preferred embodiments, the narrow articulation angle extends from between two degrees up to four degrees. In still other preferred examples, the narrow articulation angle extends from between one degrees and four degrees or in other preferred embodiments from three degrees (or one degrees or two degrees) to five degrees.

The coupler of FIG. 9B could in some preferred embodiments be a cruciform such as that shown in FIG. 12. In that case, the torque between the first and second joint members is transmitted both (a) directly from the first joint member to the second joint member via side walls of the two pairs of cones or cone slices and (b) via the cruciform. As noted, in the preferred embodiment depicted in FIG. 10 through FIG. 12, the torque transmission may be shared between the coupler 40, for example a cruciform 40A, and the walls of the cones (or cone slices) of the joint members 20, 30. Although the embodiment of FIGS. 10-12 has been shown with cones, it is specifically noted that the “shared torque” embodiment of FIGS. 10-12 can be incorporated into the “cone slice” embodiment of FIGS. 9a and 9B by using the cruciform coupler of FIGS. 10-12.

As shown in FIGS. 10-12, the present invention may be described as a universal joint 10. The universal joint 10 may comprise a first joint member terminating in either a first pair of cones or a first pair of cone slices, wherein apical ends of said first pair of cones or first pair of cone slices form first and second sockets, the first and second sockets facing each other. The universal joint may further comprise a second joint member terminating in either a second pair of cones or a second pair of cone slices, wherein apical ends of said second pair of cones or second pair of cone slices form third and fourth sockets, the third and further sockets facing each other. The universal joint may further include a cruciform coupler fitted into the first, second, third and fourth sockets, wherein the torque between the first and second joint members is transmitted jointly by being transmitted both (a) directly from the first joint member to the second joint member via external walls of the two pairs of cones or cone slices and (b) via the cruciform.

As shown in FIG. 12, the cruciform 40A may have a central portion 41 from which the two pairs of opposite projections of the cruciform extend. The shape of the central portion may vary from a cylinder to a cube or even a sphere. The two pairs of projections 43, 44 of the cruciform may extend outward in a cylindrical shape that may match and fit into the cylindrically-shaped sockets of the first and second joint members 20, 30. In the cruciform coupler 40A shown in FIG. 12, central portion 41 is substantially cylindrical and shaped like a cylinder truncated by flat faces from which the two pairs of projections 43, 44 (two of the four projections are not seen) extend. Accordingly, whereas in the other preferred embodiments that utilize a spherical coupler 40 each of the sockets 23, 25, 33, 35 may be shaped as a quadrant of a sphere, in the preferred embodiment shown in FIGS. 10-12, the sockets at the end of the joint members 20, 30 may be cylindrical.

In certain preferred embodiments of FIGS. 10-12, first and second joint members 20, 30 terminate in respective first and second pairs of cones. Each of four cones 22, 24, 32, 34 of the first and second pairs of cones may be in constant contact with two adjacent cones. For example, the first pair of cones may comprise a first cone and a second and the second pair of cones may comprise a third cone and a fourth cone. Accordingly, torque may be transmitted to and from each of the first and second cones to and from each of the third and fourth cones since walls of the first cone may be in contact with walls of the third and fourth cones and walls of the second cone may likewise be in contact with walls of the third and fourth cones.

The four cones of FIG. 12 (or FIG. 6B) may also be referred to as ears. The walls of the cones/ears may also be referred to beveled faces, particularly since at least in FIG. 12 the cones/ears are not long enough (from base to apical end) to immediately look like a cone. For example, beveled surface 24A of cone 24 has been labeled in FIG. 8A, and beveled surface 34A of cone 34 has been labeled in FIG. 8A.

In other versions of the preferred embodiments of FIGS. 10-12, the first and second joint members 20, 30 terminate in respective first and second pairs of cone slices and each of four cones slices of the first and second pairs of cones may be in constant contact with two adjacent cone slices.

As shown in FIG. 10, the first and second joint members are shown in a somewhat articulated and not a fully straight configuration. The first and second cones face each other along a first axis and the third and fourth cones face each other along a second axis that is substantially perpendicular to the first axis. If the joint members 20, were in a straight configuration lying on the same longitudinal axis, the first and second axes would also be perpendicular or substantially perpendicular to the longitudinal axis. FIG. 10 also depicts a pin, P, that is used to hold the cruciform coupler 40A.

While the invention has been described with respect to a limited number of embodiments, it will be appreciated that many variations, modifications and other applications of the invention may be made. Therefore, the claimed invention as recited in the claims that follow is not limited to the embodiments described herein.

What is claimed is:

1. A universal joint, comprising:
a first joint member terminating in either a first pair of cones or a first pair of cone slices, wherein apical ends of said first pair of cones or first pair of cone slices form first and second sockets, the first and second sockets facing each other;
a second joint member terminating in either a second pair of cones or a second pair of cone slices, wherein apical ends of said second pair of cones or second pair of cone slices form third and fourth sockets, the third and fourth sockets facing each other;
a coupler fitted into the first, second, third and fourth sockets,
wherein torque is transmitted directly between the first joint member and the second joint member via side walls of the two pairs of cones or cone slices.

2. The universal joint of claim 1, wherein the apices of the four cones or cone slices of the first and second pairs of cones or cone slices are coincident.

3. The universal joint of claim 1, wherein all of the torque between the first and second joint members is transmitted directly between the first joint member and the second joint member.

4. The universal joint of claim 1, wherein the coupler occupies a spherical segment.

5. The universal joint of claim 1, wherein the coupler is substantially spherical.

6. The universal joint of claim 1, wherein the coupler does not transmit torque between the first and second joint members.

7. The universal joint of claim 1, wherein the first and second joint members terminate in respective first and second pairs of cones.

8. The universal joint of claim 7, wherein a side wall of each cone of the first pair of cones is in constant contact with side walls of both cones of the second pair of cones and wherein a side wall of each cone of the second pair of cones is in constant contact with side walls of both cones of the first pair of cones.

9. The universal joint of claim 1, wherein the first and second joint members terminate in respective first and second pairs of cone slices.

10. The universal joint of claim 9, wherein a side wall of each cone slice of the first pair of cone slices is in constant contact with side walls of both cone slices of the second pair of cone slices and wherein a side wall of each cone slice of the second pair of cone slices is in constant contact with side walls of both cone slices of the first pair of cone slices.

11. The universal joint of claim 1, wherein the first pair of cones comprise a first cone and a second cone and the second pair of cones comprise a third cone and a fourth cone, and wherein when the first and second joint members are in a straight configuration and lie on a longitudinal axis, the first and second cones face each other along a first axis substantially perpendicular to the longitudinal axis, and the third and fourth cones face each other along a second axis that is substantially perpendicular both to the longitudinal axis and to the first axis.

12. The universal joint of claim 11, wherein base ends of each cone of the first and second pairs of cones are beveled ears.

13. The universal joint of claim 1, wherein an apex angle of each cone or cone slice of the first pair of cones or cone slices is equal and wherein an apex angle of each cone or cone slice of the second pair of cones or cone slices is equal.

14. The universal joint of claim 1, wherein an apex angle of a cone or cone slice of the first pair of cones or cone slices is unequal to an apex angle of a cone or cone slice of the second pair of cones or cone slices.

15. The universal joint of claim 1, further comprising a lock ring around a neck of at least one of the first and second joint members, the lock ring slidable from a locked position closer to the coupler to an unlocked position further from the coupler.

16. The universal joint of claim 15, wherein release of the lock ring allows disconnection of the universal joint by exerting a manual force to pull apart a pair of cones or cone slices.

17. The universal joint of claim 1, wherein a slot for facilitating disconnection of the universal joint extends from a neck of at least one of the first and second joint members at a proximal end of the at least one of the first and second joint members to at least one of the first, second, third and fourth sockets.

18. A short universal joint for high torque having a narrow articulation angle, the universal joint comprising:
a first joint member terminating in a first pair of cone slices, wherein apical ends of said first pair of cone slices form first and second sockets, the first and second sockets facing each other;
a second joint member terminating in a second pair of cone slices, wherein apical ends of said second pair of cone slices form third and fourth sockets, the third and further sockets facing each other;
a coupler fitted into the first, second, third and fourth sockets,
wherein torque is transmitted directly between the first joint member and the second joint member via side walls of the two pairs of cone slices and not through the coupler.

19. The universal joint of claim 18, wherein the narrow articulation angle extends up to five degrees.

20. A universal joint, comprising:
a first joint member terminating in either a first pair of cones or a first pair of cone slices, wherein apical ends of said first pair of cones or first pair of cone slices form first and second sockets, the first and second sockets facing each other;
a second joint member terminating in either a second pair of cones or a second pair of cone slices, wherein apical ends of said second pair of cones or second pair of cone slices form third and fourth sockets, the third and further sockets facing each other;
a cruciform coupler fitted into the first, second, third and fourth sockets,
wherein the torque between the first and second joint members is transmitted jointly by being transmitted both (a) directly from the first joint member to the second joint member via external walls of the two pairs of cones or cone slices and (b) via the cruciform.

21. The universal joint of claim 20, wherein the first, second, third and fourth sockets are cylindrical.

22. The universal joint of claim 20, wherein each of four cones of the first and second pairs of cones are in constant contact with two adjacent cones.

23. The universal joint of claim 20, wherein each of four cones slices of the first and second pairs of cones are in constant contact with two adjacent cone slices.
